(19) United States
(12) Patent Application Publication
(10) Pub. No.: US 2010/0207003 A1
(43) Pub. Date: Aug. 19, 2010

(54) Support Clamp

(76) Inventors: Adrian A. Bruno, Rolling Meadows, IL (US); Mario Mata Gonzalez, Kenosha, WI (US)

Correspondence Address: DAVID I. ROCHE;BAKER & MCKENZIE LLP, 130 EAST RANDOLPH DRIVE, CHICAGO, IL, 60601, US

(21) Appl. No.: 12/572,946

(22) Filed: Oct. 2, 2009

Related U.S. Application Data
(60) Provisional application No. 61/102,853, filed on Oct. 5, 2008.

(51) Int. Cl. F16M 13/02

(52) U.S. Cl. 248/231.21

(57) ABSTRACT

A support comprising a generally C-shaped body having two free ends and bridging section. A threaded clamping bolt extending through the clamping bolt has a pivoting jaw at one end and a knob at the other end. The clamp body has a first passageway extending through the bridging section of the clamp body, the first passageway extending in a direction generally parallel to a direction defined by a position of the clamping bolt. The clamp body has second passageway extending through its distal end. The second passageway is generally perpendicular to the first passageway. The two passageways intersect at a grip point, and a set screw or bolt at the grip point communicates with the first and second passageways. The set screw is adapted to hold an elongated member in fixed positions while the elongated member extends through either one of the two intersecting passageways.

### BACKGROUND

The devices described and claimed herein relate generally to a way of supporting a light or other object in a variety of positions, and is particularly applicable to supports for lights used to illuminate a grill or similar work area.

There are a number of lighting supports that are hold a lamp in place by clips and clamps. In addition, there are lights for grills that are integrated into or otherwise attached to the handle of a grill. See, for example, U.S. Pat. No. 6,851,820, entitled “Barbecue Grill Light”, and U.S. Pat. No. 6,132,055, entitled “Barbecue Light”. Still others have lights that are integrated into a portion of the grill other than the handle, such as a shelf that accompanies the barbecue grill. See US Publication No. 20030111070, entitled “Illuminating Lamp System for Unique Barbecue”. The growth and popularity of outdoor grilling and the resulting wide variety of grills and adjacent work areas have given rise to the need for an adaptable support apparatus for use with an adjustable and flexible arm or “Gooseneck” that firmly holds the light (or other object) in place and that can be attached to either a horizontally extending surface, such as a table top, or a vertically extending surface, such as a wall or fence.

### SUMMARY

The light support disclosed herein is comprised of a clamp including a clamping bolt and a clamp body with two generally perpendicular elongated openings or pathways that preferably intersect, such that a single set screw at the point of intersection may be used to hold the neck of a lamp (or similarly configured object), as it extends though either of the pathways. A first pathway extends in a direction generally parallel to the axis of the clamping bolt and is typically used to hold the neck when the clamp body is affixed to a horizontal surface such as a table or countertop. A second pathway extended in a direction generally perpendicular to the first pathway and perpendicular to the clamping bolt, and is typically used to hold the neck when the clamp body is affixed to a vertical surface such as a wall or fence. By providing a support that can be used in two alternative orientations, along with a flexible gooseneck-type holder for a lamp, the device disclosed allows a user to put a lamp virtually anywhere, and will firmly hold the lamp in place.

### BRIEF DESCRIPTION OF THE DRAWINGS

These and other features, aspects, objects, and advantages of the inventions described and claimed herein will become better understood upon consideration of the following detailed description, appended claims, and accompanying drawings where:

FIG. 1 is an exploded view of a clamp and lamp in combination as they would be oriented when the clamp is attached to a generally horizontal supporting surface;

FIG. 2 is an exploded view of a clamp and lamp in combination as they would be oriented when the clamp is attached to a generally vertical supporting surface;

FIG. 3 is an enlarged perspective views of the clamp body of the devices show in FIGS. 1 and 2; and

FIG. 4 is a partially exploded elevational view of the assembly shown in FIGS. 1 and 2.

It should be understood that the drawings are not necessarily to scale and that the embodiments are sometimes illustrated by graphic symbols, phantom lines, diagrammatic representations and fragmentary views. In certain instances, details which are not necessary for an understanding of the inventions described and claimed herein or which render other details difficult to perceive may have been omitted. It should be understood, of course, that the inventions described herein are not necessarily limited to the particular embodiments illustrated herein.

Like reference numerals will be used to refer to like or similar parts from Figure to Figure in the following description of the drawings.

### DETAILED DESCRIPTION OF THE DRAWINGS

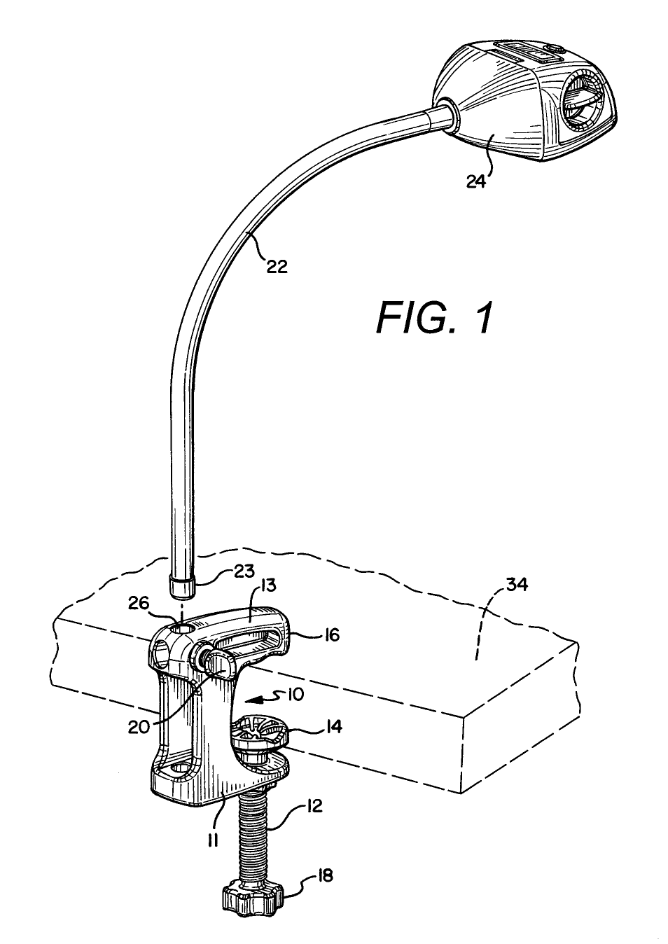

Referring first to FIG. 1, the clamp body 10 has proximal end 11 to which is attached a clamping bolt 12 with a floating jaw 14. The distal end 13 of the clamp body 10 comprises a fixed jaw 16. As a user turns the knob 18, the floating jaw 14 is brought either closer to or away from the fixed jaw 16, to hold the clamp body to, or loosen the clamp body from, a supporting surface 34. In FIG. 1 is the supporting surface 34 is show as being in a generally horizontal orientation. In the configuration shown in FIG. 1, the lamp 24 and the distal end 23 of the flexible support arm 22 extends through a first pathway 26 that is generally parallel to the clamping bolt 12. Once the distal end 23 of arm 22 is inserted into the pathway 26, a set screw 20 may be tightened to grip the support arm 22 in the pathway 26, so that the support arm 22 does not slip easily through the pathway 26.

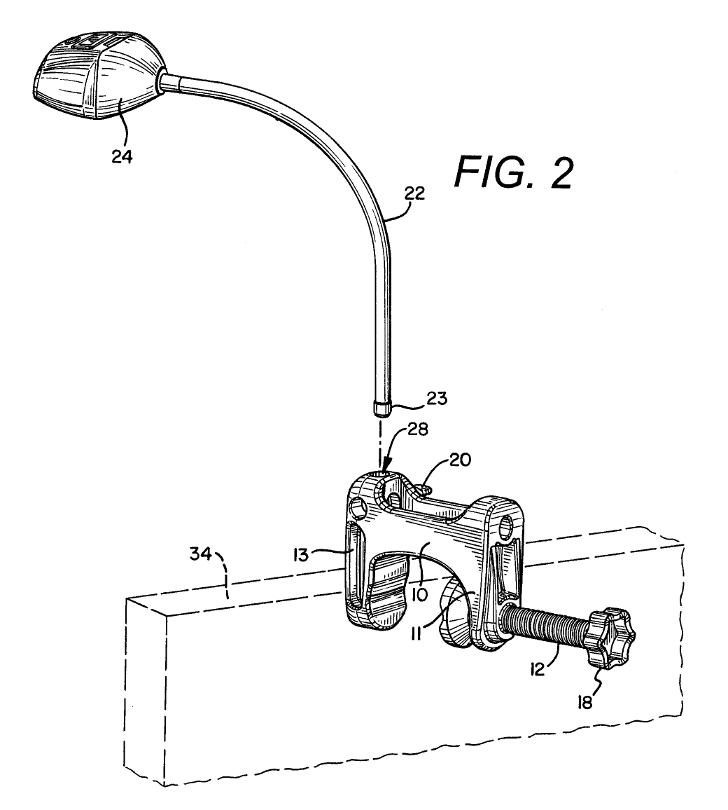

FIG. 2 shows the clamp body 10 arranged to be affixed to a generally vertically oriented supporting surface 36. In the FIG. 2 configuration, the distal end 23 of the support arm 22 may be inserted into a second pathway 28 that is generally perpendicular to and intersects with the first pathway 26. The set screw 20, which is at the intersection of the first and second pathways, may be used to hold the distal end 23 of the support arm 22, so that the support arm does not slip easily in the second pathway 28. The same set screw 20 acts as a grip to hold the support arm regardless of which pathway, 26 or 28, is being used, because both pathways intersect the opening through which the set screw passes and is threaded.

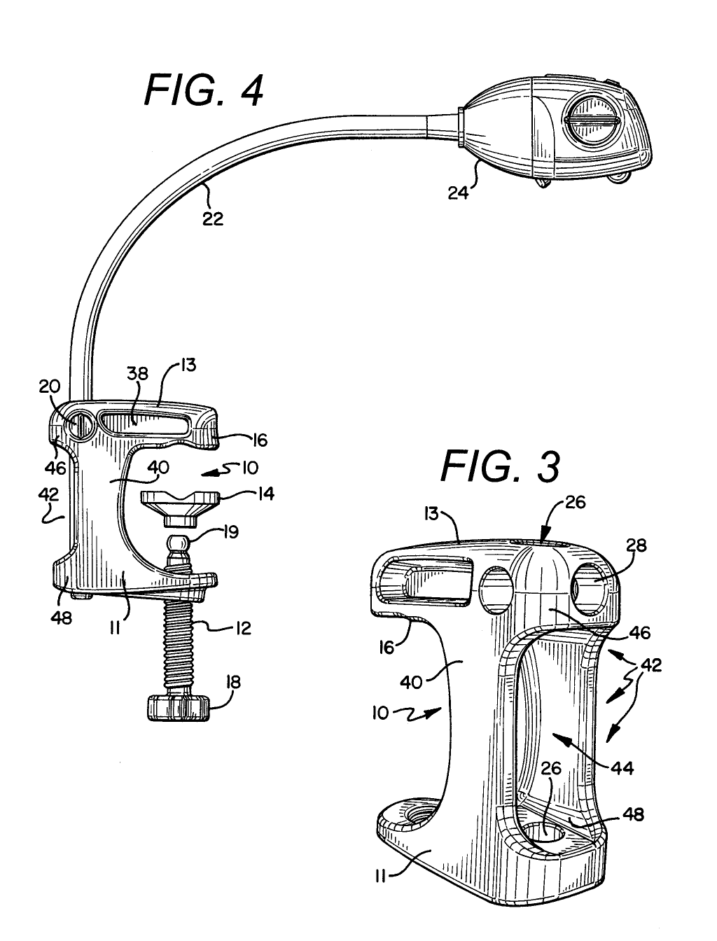

FIG. 3 is an enlarged perspective view of the clamp body 10 shown in FIGS. 1 and 2. The clamp body 10 is preferably made of plastic with a first internally threaded metal insert 30 into which the set screw 20 may be threaded. A second internally threaded metal insert 32 is disposed in an opening in the proximal end 11 of the clamp body 10, and the insert 32 is adapted to threadingly receive the clamping bolt 12. The threaded inserts 30 and 32 may be insert molded into the clamp body, or may be inserted into the corresponding openings after the clamp body 10 has been molded.

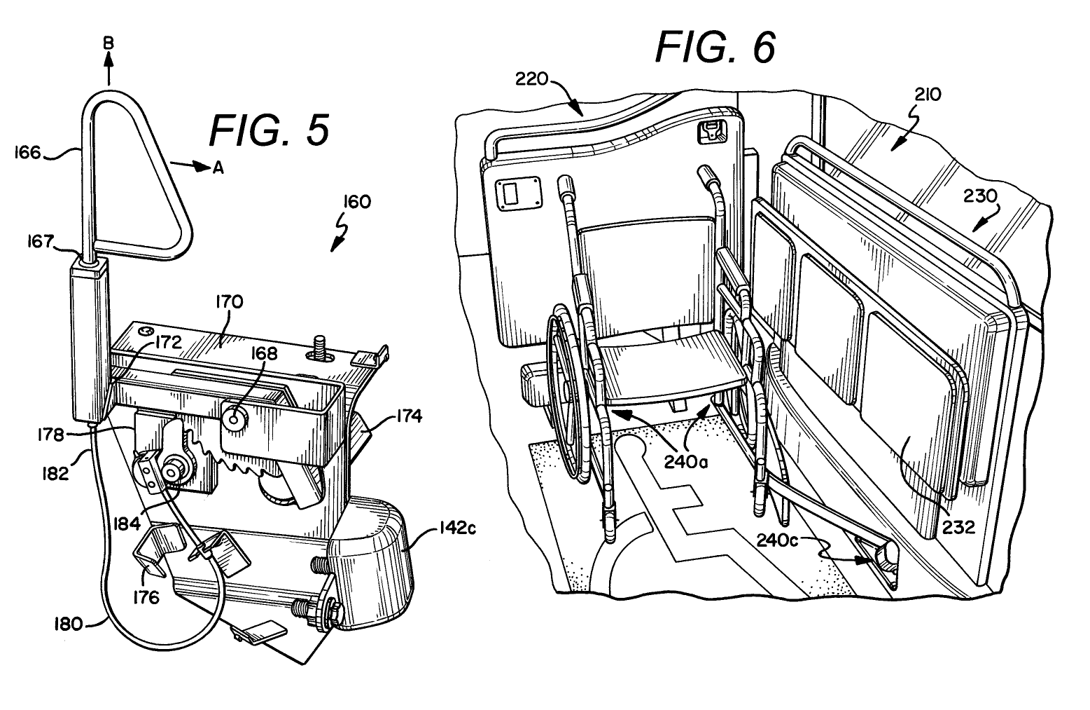

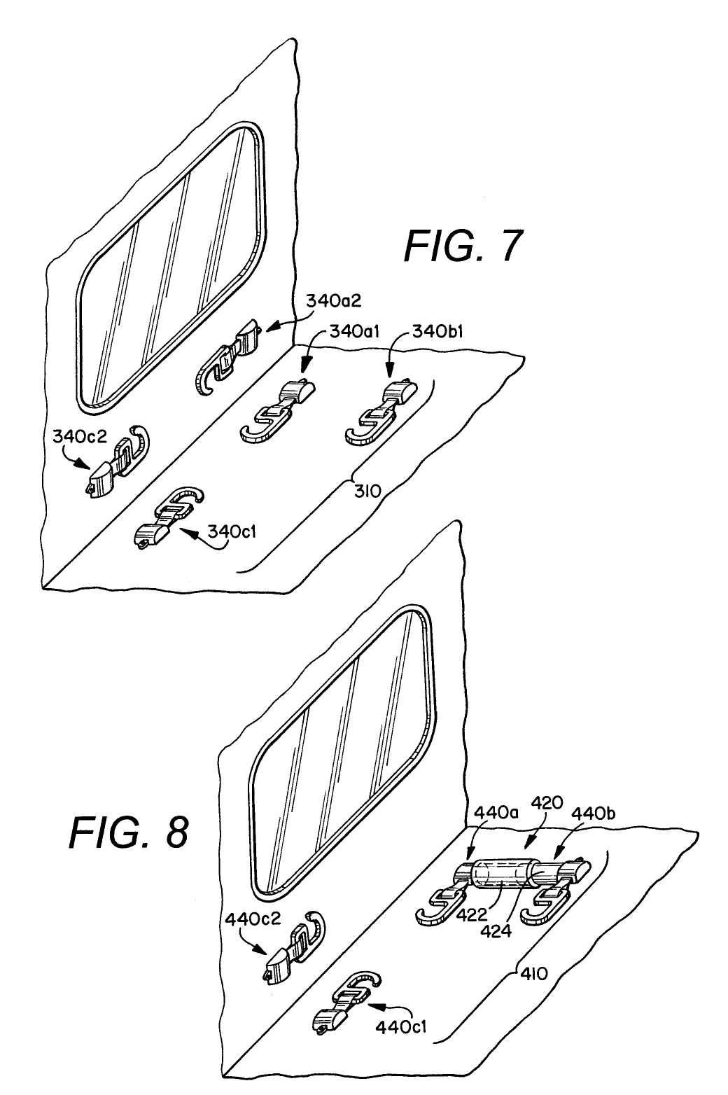

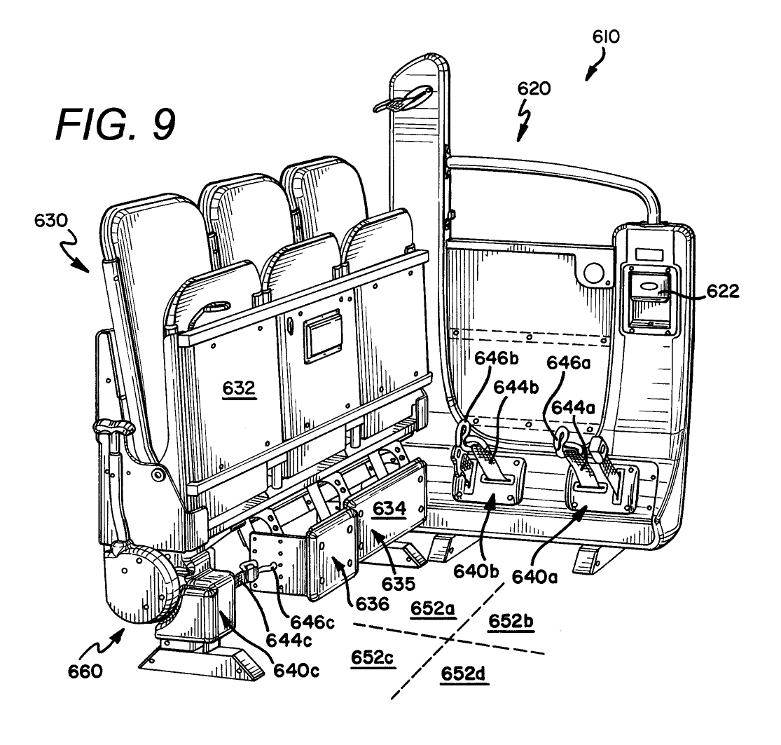

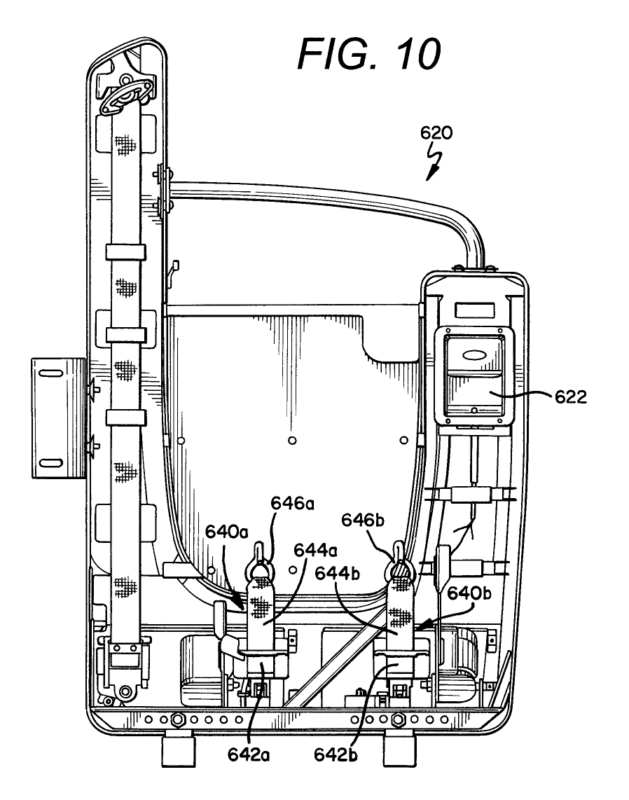

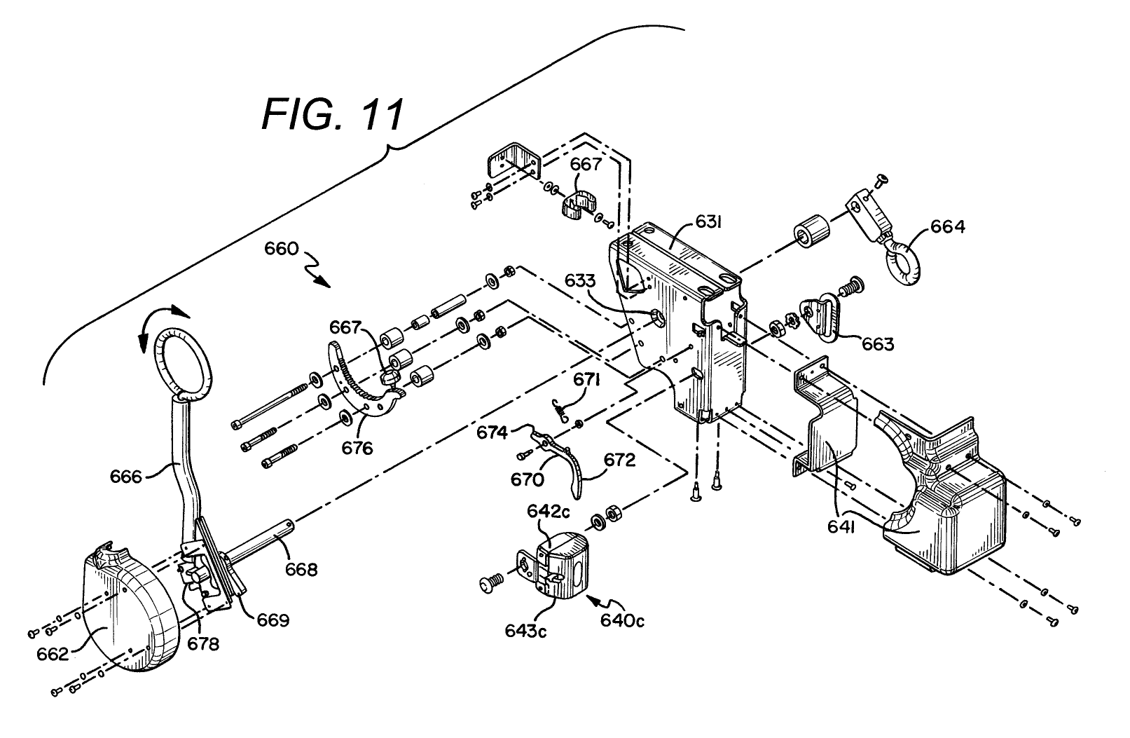

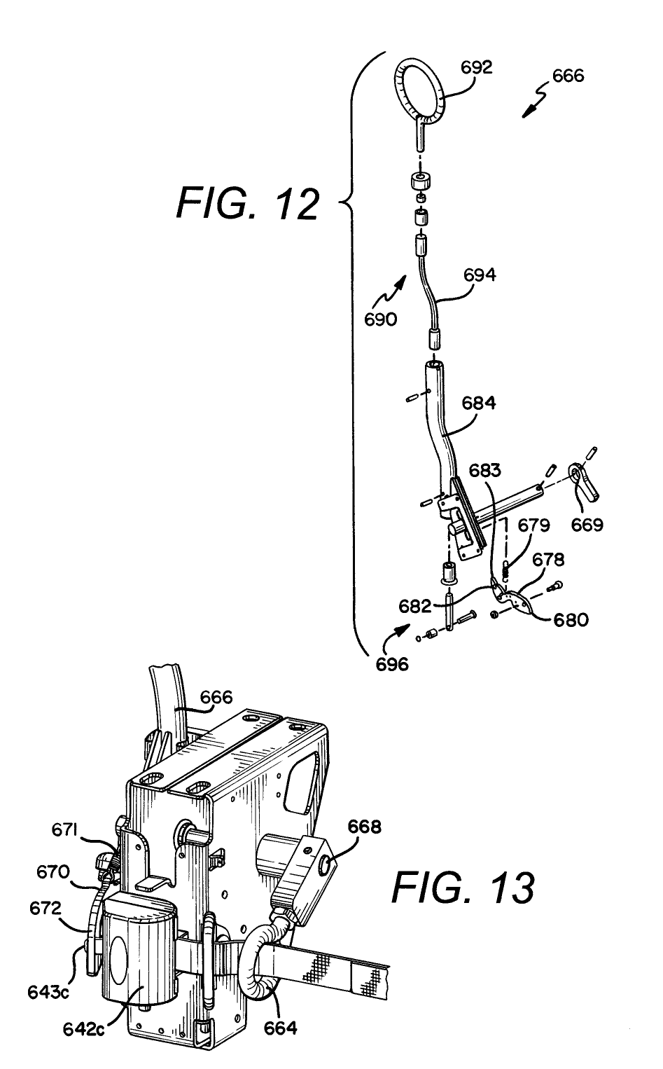

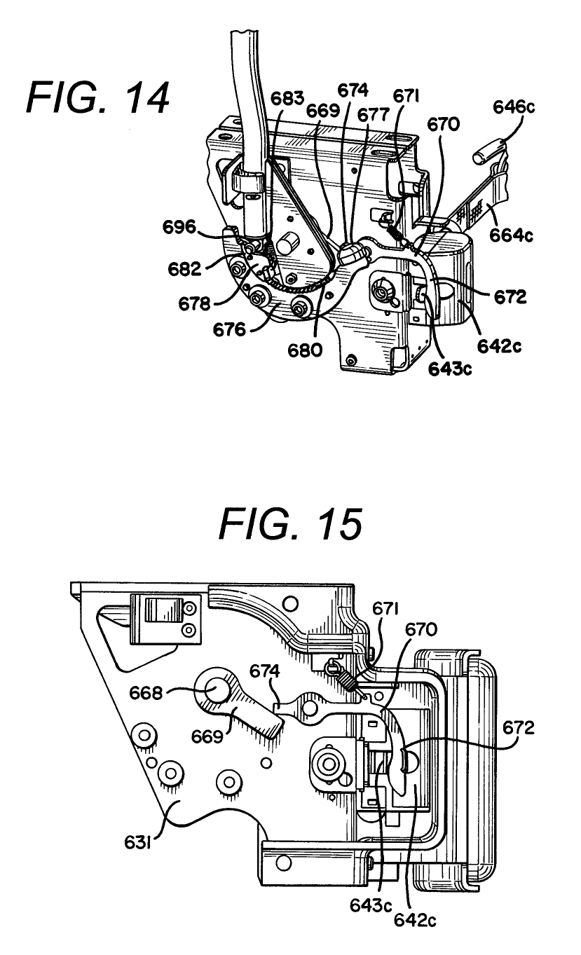

FIG. 4 is partially exploded elevational view of the clamp 10, clamping screw 12, lamp 24 and arm 22. In this view the floating jaw 14 is separated from the balled end 19 of the clamping screw 12.

For assembly purposes, the floating jaw 14 (shown in FIGS. 1 and 2) is a small pivoting plate that snaps onto a balled end 19 of the clamping bolt opposite the knob 18, after the clamping bolt has been threaded through the insert 32. The floating jaw or pivoting plate 14 is free to both pivot and rotate about the balled end 19 of the clamping bolt 12. The clamping bolt 12, the pivoting plate 14, and set screw 20 are preferably made of plastic.

The clamp body 10 has a generally C-shaped configuration. The distal end 13 through which the second or transverse pathway 28 extends has a recess 38 formed in its sides to reduce the amount of plastic used to form the clamp body. The bridging section 40 of the clamping body 10, through which the first pathway 26 extends, has a U-shaped cut-away 42 and a recess 44, which also reduce the amount of plastic used to form the clamp body, while providing the bridging section 40 with structural rigidity and strength that allows the clamp to firmly grip a supporting surface as the knob 18 is turned and the clamping bolt 12 tightened. The cut-away 42 and the recess 44 in the clamp body 10 result in the first passageway being defined by two sleeves 46 and 48 disposed at opposite ends of the bridging section 40 of the clamp body.

The lamp 24 is preferably a battery operated device so that proximity to an electrical outlet is not required. However a corded lamp with a cord passing through the flexible arm 22 could also be used, in which case the pathways in the clamp body would preferably be slotted or partially open so that a cord could be threaded through the passageways without having to fit a plug through the passageways. The ability of the device shown herein to be firmly attached to either a vertically oriented surface (as shown in FIG. 1) or a horizontally oriented surfaces (as shown in FIG. 2), provides the clamp with versatility that allows the device to be used almost anywhere. When used as a support for a lamp, even more versatility can be obtained by using a flexible arm of the kind that holds it position after being moved by bending. It should be noted that the intersecting pathways 26 and 28 may be used to support items other than a lamp, such as a mirror, a sign or other item that needs to be held in a particular position.

Although the inventions described and claimed herein have been described in considerable detail with reference to certain preferred embodiments, one skilled in the art will appreciate that the inventions described and claimed herein can be practiced by other than the preferred embodiments, which have been presented for purposes of illustration and not of limitation. Therefore, the spirit and scope of the appended claims should not be limited to the description of the preferred embodiments contained herein.

1. A support device comprising a clamp body having a fixed jaw at a distal end, a moveable jaw at a proximal end of the clamp body, the clamp body having two pathways intersecting at a junction, a grip at the junction for engaging an elongated member in fixed positions while extending through either one of the two pathways.

2. A support device in accordance with claim 1 wherein a clamping bolt threaded through the proximal end of the clamp body, the clamping bolt carrying the moveable jaw on one end of the clamping bolt.

3. A support device in accordance with claim 2 wherein the grip comprises a set screw threaded through an opening in the clamp body that generally intersects the two pathways, the set screw being adapted to grip a portion of an elongated member extending through either one of the two pathways.

4. A support device in accordance with claim 3 wherein the clamp body is made of plastic, and the clamping bolt is threaded into a metal threaded insert in the proximal end of the clamp body.

5. A support device in accordance with claim 3 wherein the clamp body is made of plastic, and the set screw is threaded into a metal threaded insert at the intersection of the two pathways.

6. A support comprising a body having a first fixed jaw at a distal end of the clamp body, a second moveable jaw in the form of a pivoting plate carried by a threaded clamping bolt, the clamp body having two passages intersecting at a grip point, set screw at the grip point for holding an elongated member in fixed positions while extending through either one of the two passages, the elongated member having a lamp at one end, the elongated member being flexible and bendable to a variety of bent positions, and the elongated member being capable of holding each of said positions.

7. A support comprising a generally C-shaped body a distal end and a proximal end and a bridging section, the distal end having a fixed jaw, the proximal end having an internally threaded opening through which a threaded clamping bolt threadingly extends, the clamping bolt having a pivoting jaw mounted to one end thereof and a knob at the other end of the bolt, a first passageway in the clamp body passing through the bridging section of the clamp body, and a second passageway generally perpendicular to the first passageway extending through the distal end of the clamp body, the two passageways intersecting, an opening in the clamp body at the intersection of the two passageways for supporting a set screw, the set screw being adapted to hold an elongated member in fixed positions as the elongated member extends through either one of the two passageways.
